(19) United States
(12) Patent Application Publication
(10) Pub. No.: US 2008/0111369 A1
(43) Pub. Date: May 15, 2008

(54) Tubular crimp connection and method of forming

(76) Inventor: Giulio Pettinaroli, Via Pianelli (IT)

Correspondence Address: BROOKS KUSHMAN P.C., 1000 TOWN CENTER, TWENTY-SECOND FLOOR, SOUTHFIELD, MI, 48075, US

(21) Appl. No.: 11/600,288

(22) Filed: Nov. 15, 2006

(51) Int. Cl. F16L 17/06; B21K 1/16; F16L 33/00

(52) U.S. Cl. 285/104; 285/256; 29/890.15

(57) ABSTRACT

A tubular crimp connector is provided for attaching a valve assembly or the like to a metal pipe, a fluid tight mechanically secure manner. The connector includes a tubular section made of a metal alloy defining an axial bore sized to receive the pipe with an interior circumferential sealing surface and a plurality of integrally formed annularly spaced apart teeth oriented between the sealing surface and the connector distal end. The wall thickness of the connector in the region of the spaced apart teeth is sufficiently thin to be radially, plastically, permanently deformable by a crimping tool. It is sufficiently thick to provide a mechanically secure interconnection between the tubular connector and the metal pipe without requiring a reinforcing ferrule. The method of forming is provided in which a preform is hot forged and finish machined to the final shape.

### BACKGROUND OF THE INVENTION

1. Field of the Invention

The present invention relates to a crimp joint and a method of joining a component such as valve body to a metal pipe with a crimped joint.

2. Background Art

In order to quickly and securely affix plumbing components such as valve bodies to metal pipes, a variety of attachment structures and methods have been utilized. Solder joints or threaded pipe connectors are still commonly used, however, these joints are very time consuming to form. Over the years, there have been numerous attempts to form crimp joints which can be pressed in place using mechanical or electro-mechanical crimping tools, eliminating the need for soldering or forming a threaded end on the pipe. Traditional crimp joints typically utilize an annular seal and one or more metal lock rings. These rings are typically formed of steel and may cause corrosion problems in certain applications. The use of separate metal rings further adds additional cost of manufacturing a valve assembly or other product having a crimp connector and can make the installation process somewhat more tedious for the installer.

### SUMMARY OF THE INVENTION

The present invention is designed to provide a very secure and simple cost effective crimp joint eliminating the need for a separate metal crimp ring or a external ferrule. The present invention can be embodied in a tubular fitting which can be incorporated into a valve assembly or the like for attachment to a metal pipe or the invention may alternatively be directly incorporated into one of the valve assembly sub-components. In either event, the valve assembly or tube ferrule has an axial elongate tubular connector section made of a metal alloy which is generally tubular in shape and preferably, made from a near-net shape preform member which is subsequently machined. A finish machined tubular connector defines a proximate end, a distal end and a tubular portion extending there between and aligned along a generally circular cylinder axial bore. The axial bore is sized to receive a predetermined diameter round circular cylindrical metal pipe. The interior circumferential bore defines an interior circumferential sealing surface and a plurality of integrally formed, annularly spaced apart inwardly projecting teeth which are oriented axially between the circumferential sealing surface and the distal end of the tubular connector.

The tubular connector section has a wall thickness in the axial region of the annularly spaced teeth which is sufficiently thin, so it can be radially, plastically and permanently deformed by a crimp tool in order to inwardly urge the plurality of teeth into interfering engagement with the outer periphery of a metal pipe within the axial bore. The tubular section is further sufficiently thick to provide a secure, mechanical interconnection between the tubular connector and the pipe so that the structural integrity of the joint can be maintained during normal use without requiring a reinforcing ferrule. Once the tubular section is crimped in place about the metal pipe, circumference and fluid tight connection with the outer periphery of the metal pipe is formed with the circumferential sealing surface and the tubular connector.

In a preferred embodiment of the invention, the circumferential sealing surface is provided with an annular groove sized to receive an annular sealing ring. Preferably, the annular sealing ring is toroidal and made up of polymetric elastic material.

In the preferred embodiment of the invention, the tubular connector section is initially formed near-net shape using a hot forging process and subsequently finish machined out of a material which is compatible from a corrosion standpoint with the material on the metal pipe to which it is to be attached. When used with copper pipe, the metal alloy used to form the tubular connector section may be a copper base alloy such as brass or bronze.

In a preferred embodiment of the invention, the inwardly projecting teeth are six or more in number and are generally, uniformly, circumferentially spaced about the axial bore. In an embodiment invention, the teeth form arcuate segments having an axial cross-section which is wider at the base and relatively narrower at the gradually inwardly projected tip.

The invention further includes a method of forming a tubular fitting for attachment to a round metal pipe. The method comprises selecting a metal alloy compatible with the round metal pipe material to which it is to be joined. The metal alloy slug is hot forged to create a near-net shape tubular preform. The preform is then finish machined to form a body having a proximate end, a distal end and a tubular portion extending there between providing a generally circular cylindrical axial bore sized to receive the round metal pipe. The axial bore is provided with an annular sealing surface, preferably an annular groove, and a plurality of integrally formed, annularly space apart, inwardly projecting teeth which are axially oriented between the sealing surface and the distal end. Where the sealing surface comprises an annular groove, an annular elastomeric seal is installed in the interior circumferential groove for cooperation with the metal pipe periphery. The tubular connector, when finish machined, has a wall thickness in the region of the annularly spaced apart teeth which is sufficiently thin to be radially, plastically, permanently deformed by a crimp tool in order to inwardly urge the plurality of teeth into interfering engagement with the outer periphery of the metal pipe and inserted in the axial bore. The wall thickness is sufficiently thick to provide a mechanically secure interconnection between the tubular fitting and the metal pipe which can withstand mechanical loads of normal use without requiring a reinforcing ferrule. Once crimped in place, the interior circumferential sealing surface forms a fluid tight connection with the outer periphery of the metal pipe. Preferably, the tubular fitting is formed with an annular flange adjacent the distal end for connection to the body of a valve or the like or integrally formed into a portion of a valve body.

### BRIEF DESCRIPTION OF THE DRAWINGS

FIG. 1 is a cross-sectional perspective view of a hot formed preform used to fabricate the present invention;

FIG. 2 is a cross-sectional view of a finish machined tubular connector of the present invention; and

FIG. 3 is a ball valve assembly which incorporates a tubular crimp connector of the present invention.

### DETAILED DESCRIPTION OF THE PREFERRED EMBODIMENT(S)

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to utilize the present invention.

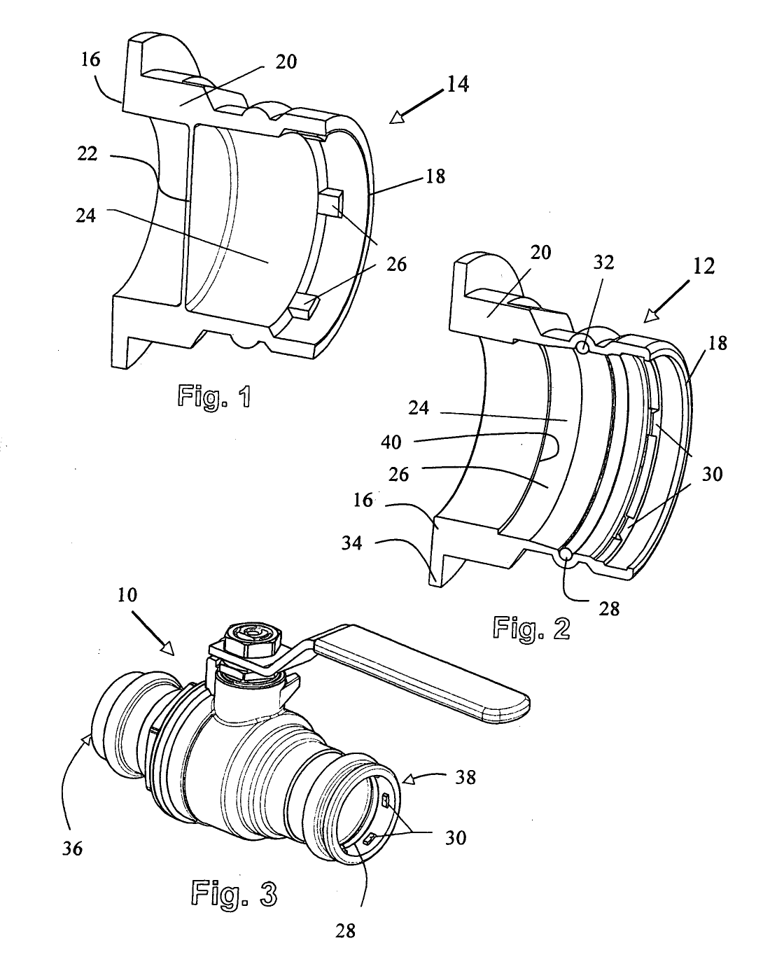

Referring now to FIGS. 1-3, the tubular crimp connection and method of forming same will be described. The tubular crimp connection can be an integral part of a valve assembly 10 as shown in FIG. 3 or a tubular fitting 12 as shown in FIG. 2. In either event, the tubular connection is preferably formed from a near-net shape preform 14 as illustrated in FIG. 1. The near-net shape preform can be formed using a hot forging process from a metal alloy slug of a material which is selected to be compatible with material of a metal pipe to which the tubular connector is ultimately intended to be attached. For example, if the tubular connector is intended to be used with a copper pipe, a compatible metal alloy such as brass or bronze may be utilized.

Preform 14 is generally tubular in shape having a distal end 16, a proximate end 18 and generally tubular portion 20 extending there between. Web 22 is an artifact of the forging process and will be subsequently removed during finish machining. A tubular preform defines a generally cylindrical axial bore 24, which in the embodiment illustrated, has a series of lugs 26 spaced about the periphery of the inner periphery of the inner cylindrical surface of the preform.

The preform 14 is finish machined to its final shape illustrated in FIG. 2. As cylindrical axial bore 24 is formed with an inner circumferential sealing surface which in the FIG. 2 embodiment further comprises an annular groove 28. A plurality of integrally formed annularly spaced apart teeth 30 are machined from lugs 26 in the preform. Ideally, there is at least six inwardly projecting teeth 30 which are generally evenly circumferentially spaced about the circumferential bore. Ideally, each of the teeth 30 will be an arcuate circumferential segment having an axial cross-section which is generally triangular with a large base and a relatively narrow tip.

In the preferred embodiment of the invention illustrated in FIG. 2, an annular seal 32 is provided within circumferential groove 28. The seal can be a soft metal or an elastic polymeric material such as an “O” ring having a toroidal shape.

In the preferred embodiment of the invention illustrated in FIG. 2, tubular fitting 12 is further provided with a flange 34 formed about the tubular connector distal end 16. Flange 34 facilitates joining the tubular fitting to a valve body or the like. It should be appreciated that the tubular connector can alternatively be directly formed as part of a component of a valve assembly. The term “valve” is used broadly and although a ball valve is illustrated in FIG. 3, any number of valves may be fabricated utilizing this invention including gate valves, pressure regulators or the like.

FIG. 3 represents a ball valve 10 which incorporates a pair of tubular crimp connectors 36 and 38 at opposite axial ends of the valve. Each of the tubular crimp connectors, 36 and 38 are provided with an internal annular elastomeric seal 28 and a plurality of circumferentially spaced teeth 30. Teeth 30 are oriented between elastomeric seal 28 and the distal end of the connector.

When it is desired to attach valve 10 to a metal pipe, the free end of the pipe is inserted axially into the tubular connector until the pipe abuts shoulder 40 illustrated in FIG. 2. The installer will then place a crimping tool about the tubular connector and inwardly squeeze the tubular connector causing the tubular region of the connector proximate teeth 30 to be radially, inwardly, plastically, permanently deformed causing the plurality of teeth to interferingly engage with the outer periphery of the metal pipe. While not necessary to the practice of the present invention, a crimping tool may similarly, radially, inwardly compress the region of the tubular connector surrounding the circumferential sealing surface and if utilized, the elastomeric ring 28 to further enhance the fluid-type seal between the circumferential sealing surface and the pipe outer periphery. It should be further appreciated that an additional elastomeric seal or packing member may be provided between the plurality of teeth 30 and the distal end 18 of the tubular connector in order to prevent water or other foreign material from entering the space between the tubular connector and the pipe outer periphery.

It should also be appreciated that a wide a variety of crimping tools, either mechanical, electro mechanical or hydraulically actuated can be utilized to install tubular connectors of the present invention by simply providing jaws or tooling surfaces corresponding to the shape of the final peripheral diameter of the installed connector. As stated previously, the crimping facet can apply force to the region surrounding the teeth or to a larger region encompassing the teeth and the sealing surface. Representative examples of a crimping tool are illustrated in published U.S. patent application 2005-0241359 and European Patent application EP 1441165. The fabrication of crimping tools and the associated die sets is well within the scope of those of ordinary skill in this technical field.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A valve assembly to be attached to a metal pipe in a fluid tight and mechanically secured manner, the valve assembly comprising:
a body including a tubular connector section made of a metal alloy which is preformed into a generally tubular near-net shape member and subsequently finish machined to define a proximate end, a distal end, and a tubular portion extending therebetween providing a generally circular cylindrical axial bore sized to receive to a round metal pipe, the axial bore having an interior circumferential sealing surface, and a plurality of integrally formed annularly spaced apart inwardly projecting teeth axially spaced between the circumferential sealing surface and the distal end;
wherein the tubular connector section has a wall thickness in the region of the annularly spaced teeth which is sufficiently thin to be radially, plastically, permanently deformed by a crimp tool in order to inwardly urge the plurality of teeth into interfering engagement with an outer periphery of a metal pipe inserted within the axial bore, and sufficiently thick to provide a mechanically secure interconnection between the valve assembly and a metal pipe without requiring a reinforcing ferrule, so that once tubular connector section is crimped and the valve assembly and metal pipe securely joined together a fluid tight connection with the outer periphery of the metal pipe is formed.

2. The valve assembly of claim 1 wherein the metal alloy forming the body is a copper base alloy.

3. The valve assembly of claim 1 wherein the inwardly projecting teeth further comprise at least six generally uniformly spaced apart teeth.

4. The valve assembly of claim 3 wherein the inwardly projecting teeth further comprise a series of arcuate segments having a circumferential length greater than their axial width.

5. The valve assembly of claim 4 wherein the inwardly projecting teeth each have when view in axial cross section a relatively wide base and a narrow inwardly projecting tip.

6. The valve assembly of claim 1 wherein the interior circumferential sealing surface further forms an interior circumferential groove, and the valve assembly further comprises a polymetric annular seal located in the interior circumferential groove for forming a fluid tight connection with the outer periphery of the metal pipe.

7. A tubular fitting to be attached to a metal pipe in a fluid tight and mechanically secured manner, the tubular fitting comprising:
a body including a tubular connector section made of a metal alloy which is preformed via a hot forging process into a generally tubular near-net shape member and subsequently finish machined to define a proximate end, a distal end, and a tubular portion extending therebetween providing a generally circular cylindrical axial bore sized to receive to a round metal pipe, the axial bore having an interior circumferential groove, and a plurality of integrally formed annularly spaced apart inwardly projecting teeth axially spaced between the circumferential groove and the distal end; and
a annular seal located in the interior circumferential groove in the tubular connector section;
wherein the tubular connector section has a wall thickness in the region of the annularly spaced teeth which is sufficiently thin to be radially, plastically, permanently deformed by a crimp tool in order to inwardly urge the plurality of teeth into interfering engagement with an outer periphery of a metal pipe inserted within the axial bore, and sufficiently thick to provide a mechanically secure interconnection between the tubular fitting and a metal pipe without requiring a reinforcing ferrule, so that once tubular connector section is crimped and the tubular fitting and metal pipe securely joined together the annular seal located in the interior circumferential groove forms a fluid tight connection with the outer periphery of the metal pipe.

8. The tubular fitting of claim 7 wherein the annular seal is a toroidal shaped and formed of a polymeric material.

9. The tubular fitting of claim 7 wherein the metal alloy forming the body is a copper base alloy.

10. The tubular fitting of claim 7 wherein the inwardly projecting teeth further comprise at least six generally uniformly spaced apart teeth.

11. The tubular fitting of claim 10 wherein the inwardly projecting teeth further comprise a series of arcuate segments having a circumferential length greater than their axial width.

12. The tubular fitting of claim 11 wherein the inwardly projecting teeth each have when view in axial cross section a relatively wide base and a narrow inwardly projecting tip.

13. The tubular fitting of claim 7 wherein the proximate end of the body forms a annular flange.

14. A method of forming a tubular fitting for attachment to a round metal pipe, the method comprising:
selecting a metal alloy which is compatible and corrosion resistant when joined to a round metal pipe to which it is to be attached;
hot forging a metal alloy slug to create a near net-shape tubular preform;
finish machining the tubular preform to form a body having a proximate end, a distal end, and a tubular portion extending therebetween providing a generally circular cylindrical axial bore sized to receive to the round metal pipe, the axial bore having an interior circumferential groove, and a plurality of integrally formed annularly spaced apart inwardly projecting teeth axially spaced between the circumferential groove and the distal end; and
installing an annular seal in the interior circumferential groove in body axial bore;
wherein the tubular connector section has a wall thickness in the region of the annularly spaced teeth which is sufficiently thin to be radially, plastically, permanently deformed by a crimp tool in order to inwardly urge the plurality of teeth into interfering engagement with an outer periphery of a metal pipe inserted within the axial bore, and sufficiently thick to provide a mechanically secure interconnection between the tubular fitting and a metal pipe without requiring a reinforcing ferrule, so that once tubular connector section is crimped and the tubular fitting and metal pipe securely joined together the annular seal located in the interior circumferential groove forms a fluid tight connection with the outer periphery of the metal pipe.

15. The method of claim 14 wherein the step of hot forging further comprises forming a annular flange on one end of the preform, and the step of finish machining further comprises forming an attachment flange on the distal end of the tubular connector section.

16. The method of claim 15 further comprising joining the attachment flange of the tubular connector to a valve body.
